(19) United States
(12) Patent Application Publication
(10) Pub. No.: US 2008/0216689 A1
(43) Pub. Date: Sep. 11, 2008

(54) Device and Method for Recognition of Register Errors

(76) Inventor: Matthias Riepenhoff, Bern (CH)

Correspondence Address: RATNERPRESTIA, P O BOX 980, VALLEY FORGE, PA, 19482-0980, US

(21) Appl. No.: 11/578,906

(22) PCT Filed: Mar. 17, 2005
(86) PCT No.: PCT/EP05/02854

§ 371 Date: Sep. 18, 2007

(30) Foreign Application Priority Data
Apr. 22, 2004 (DE) 10 2004 020 197.8
Jun. 9, 2004 (DE) 10 2004 028 056.8

(51) Int. Cl. B41F 13/24

(52) U.S. Cl. 101/248

(57) ABSTRACT

A device for ascertaining a register deviation in the printing colours of a printing machine, comprising: a preliminary printing stage, from which a position of colour components can be determined as a target value; at least one sensor configured to measure the printed position of the colour components; and a computational unit configured to compare the position of the colour components determined from the preliminary printing stage with the position of the colour components measured by the sensor. A method for ascertaining the relative position of printing colours on a printed web in a printing machine is also provided.

This application is the U.S. national phase application of PCT International Application No. PCT/EP2005/002854, filed Mar. 17, 2005, which claims priority to German Patent Application No. DE 10 2004 020 197.8, filed Apr. 22, 2004 and German Patent Application No. DE 10 2004 028 056.8, filed Jun. 9, 2004.

### BACKGROUND OF THE INVENTION

1. Technical Field

The invention relates to a device and a method for identifying register errors and for monitoring colouring, in particular for identifying register errors in rotary printing.

2. Description of the Related Art

In rotary printing methods, such as for example offset printing methods for printing newspapers, colour originals are reproduced by separating the images to be printed into a plurality of so-called colour components and printing the colour components superimposed on a substrate, such as for example a paper web which is to be printed on, wherein four colours, namely cyan, magenta, yellow and black, are often used. The printing result can be improved by using other, special colours.

When printing different colour components onto the same substrate, printing the colour components superimposed as exactly as possible is decisive for the quality of the image to be printed and is often referred to as registration or colour register, wherein a distinction is drawn between the register in the printing direction, the so-called circumferential register, and the lateral register running transverse to this.

Adjusting the colour register manually is known, wherein an experienced printer looks for shifts in the colour components on highly detailed areas of the image or inspects additionally printed alignment marks and, based on his experience, corrects any colour register error by adjusting the printing machine.

A method is known from U.S. Pat. No. 5,018,213 for detecting marking fields which are additionally printed onto a printing web and can be processed by an automatic register control system.

### SUMMARY OF THE INVENTION

It is an object of the invention to propose a device and a method using which register accuracy can be easily checked.

This object is solved by the device and the method as described herein.

The device in accordance with the invention for ascertaining a register deviation in the printing colours of a printing machine, in particular a rotary printing machine, comprises at least one measuring means, such as for example an optical sensor, for detecting at least one section of an image, for example on a printed web, wherein said sensor is positioned in the vicinity of the printed substrate or web or the substrate or web to be printed on and can be used to measure or detect a relative or absolute position of colour components of the colours used in the printing, as an actual value. This at least one sensor is connected to a computational unit which compares the position of the individual colour components, quantitatively measured by the sensor or sensors, with the target value of the position of the colour components, as obtained from a preferably digital preliminary printing stage, in order to determine a register error from this, or monitor colouring, in accordance with the invention, i.e. the measured position of at least one colour component is compared with the position of this colour component ascertained for example from pre-print or preliminary stage data, in order for example to correct register errors.

The desired position of the individual colour components, i.e. the position of a colour relative to every other colour, is stored in the digital image data of the preliminary printing stage. This information is provided for example in the form of bitmaps which correspond to the distribution of the printed points on the printing block of the respective printing method. The digital data of the preliminary printing stage provide a position of the colour components which represents the target value to be reached by the printing method. Using the at least one optical sensor provided in accordance with the invention, the position generated in the printing method is preferably determined as an actual value for each process colour, i.e. for example the position of a colour or colour component relative to every other colour position. The computational unit can for example be used to perform a correlation method in order to determine the local deviations between the target value ascertained from the preliminary printing stage and the actual value ascertained by the at least one sensor, i.e. also for example the relative position of colours and/or the colour register or colour density.

Advantageously, one colour component such as for example black can be appointed as a reference and any shifts in the printing colours used can be ascertained relative to this reference colour. Using the device in accordance with the invention, it is thus possible to quantitatively determine errors in the colour register, i.e. errors both in the circumferential register and in the lateral register, or also the colour density, without it being necessary, as in the prior art, to print markings as well.

The device in accordance with the invention enables a comparatively simple sensor system to be used, since the locating of markings which are printed as well is omitted, and a measurement can easily be taken at any location on the printed substrate or paper web. Furthermore, in addition to identifying circumferential register errors or lateral register errors, the device in accordance with the invention also enables the colouring to be monitored.

In general, the invention can be employed in any printing method, in particular in any rotary printing method, if image data from a preliminary printing stage are provided. These digital image data obtained from the preliminary printing stage can be taken as target values and compared with the image data detected by at least one sensor, taken as actual values, wherein in an offset method, one or more printing plates are clamped onto a printing cylinder and the colour distribution is determined as an actual value for each process colour by printing onto a substrate or paper web and measuring the printing result. The invention can also be employed if printing block cylinder surfaces, on which image information is recorded, are used for printing. Furthermore, other printing methods can also be used, such as for example flexographic methods or letterpress methods or also rotogravure methods, wherein relief-like printing blocks are employed in these methods, from which corresponding digital data are likewise provided in the preliminary printing stage.

The sensor in accordance with the invention is preferably configured such that it can detect the colour distribution for different process colours, such as for example cyan, magenta, yellow, black, or also for any special colours additionally used, and can for example be a photo-receiver for detecting particular spectral ranges or a spectrometer. It is also possible for the sensor to be formed as a bundle of optical fibres, for example as a bundle of glass fibres, or to be connected to optical fibres, wherein one end of the bundle of fibres serves to detect the measured values and is preferably arranged in the vicinity of the substrate or paper web to be printed on. One or more optical sensors are arranged at the other end of the bundle of fibres, in order to quantitatively detect the optical signals, channelled through the optical fibres, relating to the colour distribution of the process colours. To this end, different spectral filters or colour filters or interference filters can for example be provided in front of different sensors, in order to use a sensor to measure the colour distribution of a specific process colour or to detect a particular spectral range.

One or more illuminating elements, such as for example lamps or LEDs, are also preferably arranged on the side of the bundle of fibres facing away from the printed substrate or printing web, and can input light into one or more strands of the bundle of optical fibres, such that using the bundle of fibres, it is possible to simultaneously illuminate a surface of the substrate or paper web to be printed on and detect the colour distribution for one or more colours. The light-emitting elements are preferably arranged between the optical sensors, such that alternately for example one fibre of the bundle of optical fibres serves to illuminate and one or more fibres serve to measure a colour distribution.

The optical sensor can on the one hand be a sensor which measures only in one dimension and detects the colour distribution along a line, such as for example a line camera. It is also possible for an optical sensor which measures in two dimensions, such as for example an area sensor, to be used. A camera can for example be provided in combination with a flash-generating element, such that the camera takes a two-dimensional measurement of a colour distribution when a flash is emitted onto the substrate to be printed on, in order to take a snapshot of the printed image or portions of it.

The optical sensor advantageously has a width of a few millimetres, such as for example a width in the range of 1 mm to 100 mm, and can for example be 5 mm in width. The length of a one-dimensional optical line sensor is preferably in the range of a few micrometres, wherein the length can for example be in the range between 1 and 30 μm or between 5 and 20 μm. The optical sensor, i.e. for example a line camera or the side of a bundle of fibres facing the diodes and/or photocells or lamps, is then advantageously arranged relative to a printing web such that the width of the optical sensor, measuring a few millimetres, lies transverse and preferably perpendicular to the direction of feed of the printing web. A one-dimensional measuring system can check register deviations in one direction, such as for example by colour-sensitive scanning an image strip in the circumferential direction.

In the region of the optical sensor, the printing web is advantageously guided via a roller, such that in the region where the process colours are measured, the printing web lies on the roller and defined measuring conditions, such as for example a constant distance from the sensor, can thus be established. Preferably, the sensor can be shifted transverse to the transport direction of the printing web, in order to be able to position the sensor at a desired measurement location, for example in accordance with digital data from the preliminary printing stage, in which the colours to be regulated are actually printed.

A position transmitter is preferably provided on the printing machine, in order to be able to detect the absolute rotational position of one or more printing cylinders, so as to enable them to be synchronised. It is therefore for example possible to pre-set a reference position, such that the position of each individual printing colour, measured by the sensor, can be ascertained relative to said reference position, and the position of the individual colour components, i.e. the position of the colour components relative to the rotational position of a printing cylinder, can therefore be determined. Using a position transmitter to ascertain a reference position is in particular advantageous if, for example in the case of a line camera, reading out the detected image lines is to be synchronised with the speed of the printed web, such that a two-dimensional measuring system can be realised using a line camera, in order for example to check the circumferential register and the lateral register. It is thus for example possible to determine, from a recording of the printed web taken at any location and at any point in time, the register position of the individual process colours relative to a reference position of the printing machine, i.e. for example relative to the rotational position of a roller or also relative to a reference colour. A position of the colour components of the process colours relative to the machine or to the rotational position of a printing cylinder can also be determined from a recording taken at a particular location and synchronised with the machine.

A regulating or control unit is advantageously provided in the printing machine, using which the rotational position of one or more printing blocks, such as for example the rotational position of printing plates, can be individually regulated in order to apply the process colours used, in order for example to eliminate measured circumferential register errors by changing the rotational position of one or more printing blocks so as to generate a printed image with no colour register errors.

In accordance with another aspect, the invention relates to a method for ascertaining register deviations, i.e. for determining the positions of at least two printing colours on a printed web, for example a printed paper web in a printing machine, relative to a target position of the printing colours pre-set by data from a preliminary printing stage, wherein reference values for at least two printing colours are obtained from image data of the preliminary printing stage, at least a portion of a printed image on the printing web is detected by at least one sensor, the reference values obtained from the image data of the preliminary printing stage are compared with the measured values of the colour distribution, detected by the at least one sensor, for the at least two printing colours or process colours, and the relative position of the printing or process colours is ascertained from this.

Advantageously, the position of one or more printing or process colours is ascertained relative to the printing machine, i.e. for example relative to a rotational position of a printing cylinder, wherein it is also possible to determine the position of one or more printing colours relative to one particular printing colour, such as for example relative to the colour black, as a reference, since black is often printed on every printing web.

A correlation method, i.e. for example calculating a cross-correlation value, is preferably used to compare the reference values obtained from the image data of the preliminary printing stage with the measured values detected by the at least one sensor and to determine from this the relative position of the printed process colours.

The measurement location for detecting at least a portion of the printed image is preferably determined from the preliminary stage data.

In accordance with another aspect, the invention relates to a method for regulating the position of at least one printing block or printing roller, wherein the relative position, ascertained in accordance with the above method, of at least one printing colour with respect to another printing colour is used to regulate the position of the printing block, in order to regulate any register error down to zero.

### BRIEF DESCRIPTION OF THE DRAWINGS

The invention is described below by way of example, on the basis of preferred embodiments. There is shown:

FIG. 1 is a schematic diagram illustrating the flow of data when ascertaining the relative position of a process colour;

FIG. 2 provides illustrative examples of a reference value obtained from a preliminary printing stage and measured values of a process colour;

FIG. 3 provides illustrative examples of basic image data contents from a preliminary printing stage and the corresponding printed image on the paper web;

FIG. 4 is a schematic diagram illustrating different types of image data in the preliminary printing stage;

FIG. 5 is a plan view of an embodiment of a sensor used in accordance with the invention, comprising one individual glass fibre for each photodiode;

FIG. 5a is a lateral view of the embodiment shown in FIG. 5;

FIG. 5b is an alternative embodiment in a lateral view;

FIG. 6 illustrates an example of measuring a process colour using a line sensor; and

FIG. 7 includes diagrams of measured process colours for determining a register error.

### DETAILED DESCRIPTION OF THE PREFERRED EMBODIMENTS

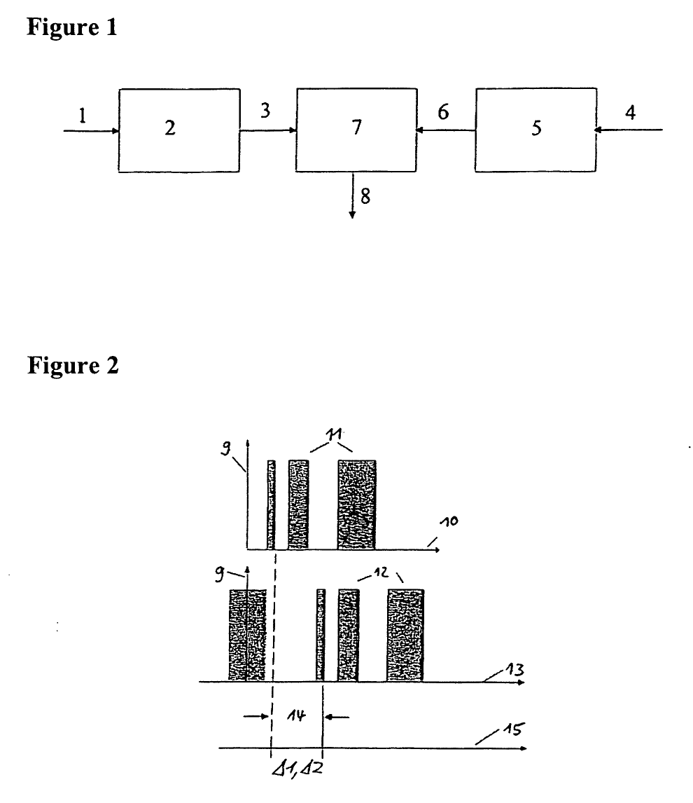

FIG. 1 shows the flow of data when calculating a colour register error of a printed paper web using digital image data of the preliminary printing stage. In a computational unit 2, reference values 3 are calculated, as target values of the relative position of two colours, from the image data 1 of the preliminary stage. The measurement signals 4 from one or more sensors, which detect the printed image on the paper web and provide information on the relative position of said two colours on the printing web, are processed in another unit 5 into measured values 6 which in a comparing unit 7 can be compared with the reference values 3. By comparing the measured values 6 with the reference values 3, a signal 8 is ascertained which indicates the colour register error of the printed paper web. The computational unit 2, the measuring unit 5 and the comparing unit 7 can be combined as one unit, for example in a PC.

FIG. 2 shows examples of reference values 11 and measured values 12 of a colour and shows by way of example how the position 14 of a colour on the printed paper web can be determined by comparing the reference values 11 and the measured values 12. The reference values 11 obtained from the preliminary printing stage are shown in a diagram in which the horizontal axis 10 indicates the distance in the vertical direction for an image from the preliminary printing stage and the vertical axis 9 indicates the brightness. In this example, the reference values 11 describe the brightness profile on a narrow vertical strip of the print original, for example a multicoloured page of a newspaper. In this example, the measured values 12 describe the brightness profile on a corresponding strip of the printed paper web in the direction of feed of the paper web, shown via the axis 13. The reference values 11 and measured values 12 in this example show similar brightness profiles. By comparing the brightness profiles of the measured values 12 and the reference values 11, it is possible to ascertain the relative shift Δ1 in a printing colour, for example using a correlation method. If the relative shift Δ2 in another printing colour is also ascertained, then the colour register error is defined by Δ1-Δ2.

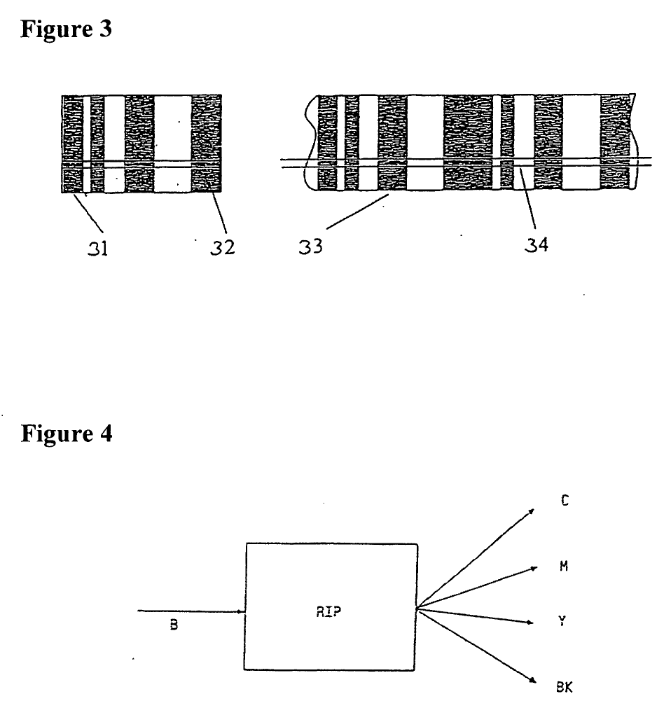

FIG. 3 shows examples of basic image data contents 31 from the preliminary printing stage and the corresponding printed image 33 on the paper web. It shows how an image strip 32 from the image original of the preliminary printing stage and a corresponding strip 34 from the printed image 33 can be selected in order to take a measurement on the paper web.

FIG. 4 shows different types of image data in the preliminary printing stage. The image data B of the contents of a page, for example a multicoloured page of a newspaper, are for example provided in Postscript format or in PDF format. Using raster image processing (RIP), the image contents for the corresponding printing plates are calculated for the process colours cyan (C), magenta (M), yellow (Y) and black (BK) from the image data B of the contents of a page. The rastered and colour-separated image data of the printing plates are for example displayed in TIFF G4 format.

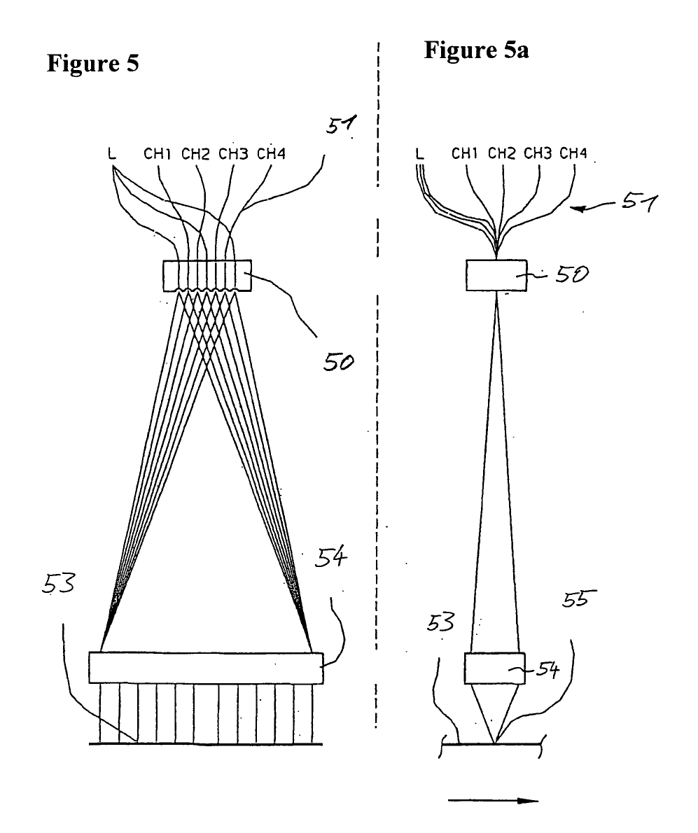

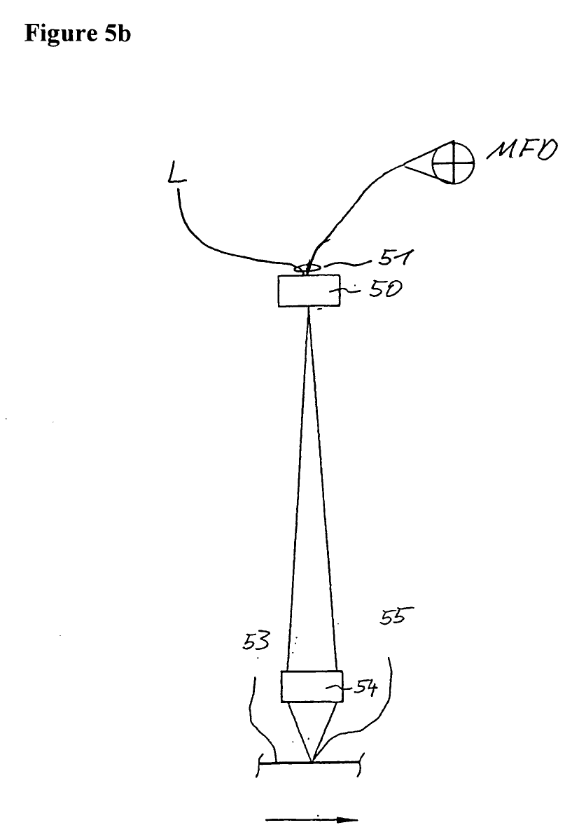

FIG. 5 shows an embodiment of a sensor which can be used in accordance with the invention in order to ascertain the colour distribution or colour density, wherein a front end of a bundle of glass fibres 51, which serves as a measuring head 50 and a lateral view of which is shown in FIG. 5a with a plurality of successively arranged front sides of individual glass fibres, is connected by individual glass fibres to a light source L which emits light from the front side of the measuring head 50 onto a printing web 53 in order to illuminate the printing web. The light reflected by the printing web 53 is absorbed by the lens system 54 and by the individual fibres of the bundle of glass fibres 51 and fed to the optical fibres lying between the light source optical fibres and assigned to the photodiodes CH1 to CH4, wherein colour filters or spectral filters can be provided in front of the individual photodiodes CH1 to CH4, in order filter out a desired spectral range of the detected light signal. The photodiodes CHI to CH4 can quantitatively detect a spectral range determined by a colour or reference filter and thus for example measure the colour distribution of printing colours on the printing web.

FIG. 5b shows an alternative embodiment of a sensor which can be used in accordance with the invention in order to ascertain the colour distribution or colour density, wherein a front end of an open, two-armed or duplex bundle of fibres 51, which serves as a measuring head 50, is connected by a fibre or arm to a light source L which serves to illuminate, and a second arm or a fibre of the bundle of fibres 51 is connected to a multiplex photodiode MFD which serves to measure the light emitted by the light source L via the measuring head 50 and the lens system 54 and reflected by the printing web 53. A plurality of duplex bundles of fibres 51 as shown in FIG. 5b can be arranged in a line, wherein for example the fibre exits of the common ends of the duplex bundle of fibres can be arranged on the measuring head 50 along a line, in order to realise an arrangement as shown in principle in FIG. 5, in which illuminating fibres and measuring fibres alternate, wherein however the multiplex photodiode MFD is provided instead of the photodiodes CH1 to CH4. Alternatively, it is also possible for example for illuminating fibres and measuring fibres to be arranged adjacently along two parallel lines, i.e. for example illuminating fibres along one line and assigned measuring fibres along a parallel line.

The reflected light which is detected by the measuring head 50 and relayed through the measuring fibre falls onto the multiplex photodiode MFD which is provided as a multiplex detector and can for example be a three-channel or four-channel photodiode with individual spectral filters for filtering different spectral ranges. Different colour filters lie for example in front of the individual areas of the multiplex photodiode MFD and can for example be embodied as interference filters. The interference layers can for example be applied to the glass cover of the photo-receiver, for example by vapour-depositing.

The embodiment shown in FIG. 5b enables a simpler design of the measuring array, wherein a cheaper bundle of fibres 51 can be used than in the embodiment shown in FIG. 5a. Electronically amplifying the signals of the multiplex photodiode MFD can also for example be realised, together with analogue/digital converting or interface functions, on a single board.

Preferably, one of the spectral filters provided in front of the multiplex photodiode MFD can also be embodied as an infrared-permeable filter, enabling the black printing colour and the superimposed printing of the other colours to be simply distinguished.

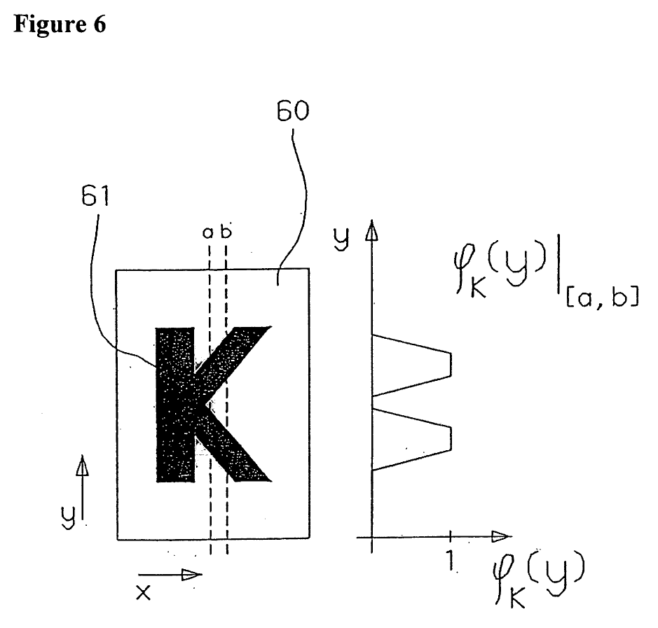

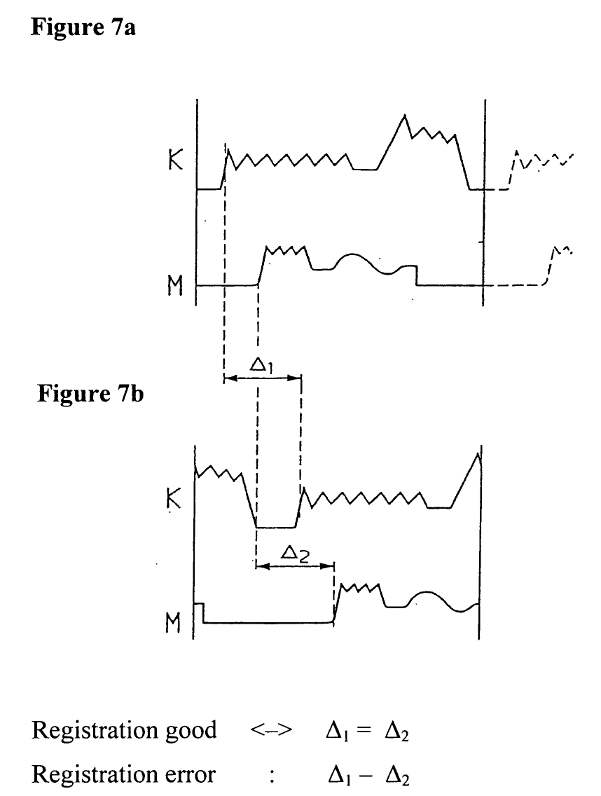

FIG. 6 shows, by way of example, an image 61 printed on a printing web 60, wherein the printing web 60 moves in the direction indicated as y and a line sensor is guided over the printing web 60 relative to the printing web 60 in the longitudinal direction between the end positions a and b indicated in FIG. 6 and thus detects a partial region of the image 61. The signal detected by the sensor is shown on the right next to the printing web 60, and shows, in the regions in which the sensor is guided over the image 61, signal profiles from which the register position can be checked, as described below by referring to FIG. 7.

FIG. 7a shows, on the basis of two colours black (K) and magenta (M), the profile or relative position of these colours, pre-set as a target value, as ascertained from the preliminary stage as a target value.

FIG. 7b shows the profile of these colours black and magenta as measured over a period, wherein it can be seen that the colour black K has a shift of Δ1 relative to the target value pre-set from the preliminary stage, and the colour magenta has a relative shift of Δ2. If Δ1 and Δ2 are identical, then there is no register error and the registration is good. A register or registration error can be ascertained by the formation of a difference between Δ1 and Δ2, wherein the register or registration error thus ascertained can be used to regulate the register position, for example by adjusting the rotational position of a cylinder.

An example of determining the circumferential register is explained below. An optical sensor 50, as shown for example in FIG. 5, is positioned at a point transverse to the web, as shown in FIG. 6, at which the colours to be checked are printed. The measurement area is set narrowly in the direction of feed y of the web and is for example 5 to 50 μm in length. Transverse to the web, the measurement area is for example about 1 mm to 100 mm or 1 to 50 mm or 5 to 20 mm in width. The reflectance at an image strip delineated between the dashed lines a and b as shown in FIG. 6, i.e. at an image strip lying in the printing direction, is measured using the optical sensor 50, wherein a plurality of spectral ranges can be detected by the photodiodes CH1 to CH4, for example by using prefixed colour filters or spectral filters 52. Alternatively, the spectral ranges can be selected by using a spectrometer. Advantageously, measurement also includes the spectral range in the near infrared range, in order for example to distinguish the black printing colour from other printing colours. Absorption filters or interference filters can for example be employed as spectral filters.

During printing, the reflectance of the web is recorded at a high scanning rate, wherein scanning can for example be temporally resolved, i.e. measured for example in scanning values or “samples” per second, or can be spatially resolved, i.e. measured for example in “samples” per web distance, wherein temporally resolved scanning can be converted into spatially resolved scanning and vice versa, if for example the web speed or the position of the printing web relative to the printing machine is known.

At a web speed of 10 metres per second, for example, a scanning rate of 500,000 samples per second corresponds to a spatial resolution of 20 μm per sample. For each scanning value or sample, the corresponding proportion of the printing colour is calculated, which is possible if for example appropriate colour filters or spectral filters are used.

From this, a colour distribution profile in the printing direction is obtained, which is correlated with a profile ascertained from the preliminary stage data. The maximum value of the cross-correlation for the black component can for example provide the position of the black component and the maximum values of the cross-correlation for the other colour components are deducted from the value of the black component and thus provide the colour register error for the individual colours in the circumferential direction.

The colour distribution of the individual colour components is ascertained from the digital data or bitmaps of the preliminary stage, which correspond to the printing formats, wherein the resolution is typically in the range of 10 μm (2540 dpi) to 25 μm (1000 dpi). A “printing block” is understood to be the sum of all the printing members mounted on a printing block cylinder, such as for example printing plates. At least one printing plate is provided per cylinder, and a plurality of plates are often arranged adjacently and/or successively.

A measurement is often also referred to as a “stream”, wherein a “stream” is characterised by the number of samples and their spacing in time. Each sample provides the colour distribution at the measurement location at the time of measurement, wherein a “stream” can in principle include any number of samples. The more values obtained by measurement, the more precisely the position of the printing colour can be ascertained by correlating between the measured values and the target values calculated from preliminary stage data.

For calculating the colour position, it is advantageous for either temporal or spatial reference information to be provided, which can also be used for correcting the registration or register error.

In order to correlate the “stream” with the image strip determined from the preliminary stage, it is advantageous if the web speed during measurement is known precisely, i.e. if temporal reference information is provided, or if a reference element exists which is measured during measurement, such as for example by scanning a rotational speed transmitter signal, in order to obtain spatial reference information.

If there is no temporal or spatial reference, then it is also possible to employ image recognition methods in order to find a correlation between measured data and target values ascertained from the preliminary printing stage. The pattern of a colour component can for example be selected as a reference, and this pattern can be identified by transforming the measured data. To this end, the measured data could be temporally or spatially stretched or compressed until a maximum correlation is reached. Conversely, it is also possible for the reference pattern to be transformed in order to obtain a maximum correlation with the measured data.

If, for a measurement, the machine speed is known but the precise time of measurement is not, then the position of the colour components relative to each other can be ascertained from this. This is advantageous, since for example a measured value transmitter for ascertaining an absolute reference value does not have to be provided and evaluated.

The samples can also be directly triggered by a reference signal generated for example by a transmitter which for example comprises an interpolator or resolution multiplier in order for example to generate 50,000 pulses per revolution. With each pulse, a measured value is sampled, corresponding to a spatial resolution of 20 μm if the circumference of the printing cylinder measures 1 m. This has the advantage of enabling measurement even during acceleration or braking phases.

The number of samples, multiplied by the corresponding spatial resolution, advantageously corresponds to one printing length. i.e. for example the circumference of a printing cylinder. However, it is also possible to detect only a portion of a printing length or more than one printing length, in order to ascertain a register error in accordance with the invention.

1. A device for ascertaining a register deviation in the printing colours of a printing machine, comprising: a preliminary printing stage, from which a position of colour components can be determined as a target value; at least one sensor configured to measure the printed position of the colour components and a computational unit configured to compare the position of the colour components determined from the preliminary printing stage with the position of the colour components measured by the sensor.

2. The device according to claim 1, wherein the sensor is a photo-receiver for detecting particular spectral ranges or a spectrometer.

3. The device according to claim 1, wherein the sensor is connected to a bundle of fibres.

4. The device according to claim 1, wherein at least one illuminating element is provided in the sensor.

5. The device according to claim 1, wherein the sensor comprises a plurality of measuring elements for separately detecting spectral ranges or is a multiplex detector.

6. The device according to claim 1, wherein one, two, three, four or more than four spectral filters or colour filters or interference filters are provided in the sensor.

7. The device according to claim 1, wherein the at least one sensor can be shifted transverse to the direction of feed of the printing web.

8. The device according to claim 1, wherein the sensor is a line sensor or an area sensor.

9. The device according to claim 1, wherein the sensor is between 1 and 100 mm in width and between 1 and 30 μm in length.

10. The device according to claim 1, wherein the sensor is provided in the vicinity of a roller over which the printing web is guided.

11. The device according to claim 1, comprising a position transmitter for determining the rotational position of at least one printing roller.

12. The device according to claim 1, further comprising a regulating unit which is coupled to the computational unit in order to regulate the rotational position of at least one printing block to facilitate compensation for a register error.

13. A method for ascertaining the relative position of at least two printing colours on a printed web in a printing machine comprising: obtaining reference values for at least two printing colours from image data of a preliminary printing stage; detecting at least a portion of a printed image on the web with at least one sensor; comparing the reference values obtained from the image data of the preliminary printing stage with the measured values detected by the at least one sensor; and ascertaining the relative position of the printing colours from the result of comparison.

14. The method according to claim 13, wherein a printing colour is used as a reference.

15. The method according to claim 13, wherein the absolute position of a printing colour is ascertained.

16. The method according to claim 13, wherein the measurement location for detecting at least a portion of the printed image on the web is obtained from the preliminary stage data of the preliminary printing stage.

17. The method according to claim 13, wherein a correlation method is performed in order to ascertain the relative position of at least one printing colour.

18. The method according to claim 13, wherein one-dimensional or two-dimensional reference values for at least two printing colours are obtained from the preliminary printing stage and are detected by the at least one sensor.

19. The method according to claim 13, wherein the position of at least one printing block is regulated in accordance with the ascertained relative position of at least two printing colours.

20. The method according to claim 13, wherein infrared light reflected by the web is detected in order to distinguish the black printing colour from the superimposed printing of the other colours.

21. The device according to claim 1, wherein the sensor is a multiplex photodiode (MFD).

22. The device according to claim 6, wherein at least one filter is infrared-permeable.

23. The method according to claim 13, wherein the printing machine is a rotary printing machine.

24. The method according to claim 14, wherein the reference colour is black.
